(19) United States
(12) Patent Application Publication
(10) Pub. No.: US 2018/0144258 A1
(43) Pub. Date: May 24, 2018

(54) NETWORK NODE, INTEGRATED CIRCUIT, AND METHOD FOR CREATING AND PROCESSING INFORMATION ACCORDING TO AN N-ARY MULTI OUTPUT DECISION TREE

(71) Applicant: NXP USA, Inc., Austin, TX (US)

(72) Inventors: Hezi Rahamim, Ranat Gan (IL); Ohad Alali, Yavne (IL); Adi Katz, Ramat Gan (IL)

(21) Appl. No.: 15/357,474

(22) Filed: Nov. 21, 2016

(51) Int. Cl. G06N 5/04

(52) U.S. Cl. CPC G06N 5/045

(57) ABSTRACT

A processor is configured to process information according to attribute value criteria organized as a decision tree, wherein an attribute value criterion of the attribute value criteria is a range of attribute values, wherein a portion of the attribute value criteria lead to a matching target value among target values of the decision tree, wherein each of the target values, including the matching target value, is assigned a respective priority value, wherein the processor is configured to count, for each specific attribute value, a respective number of particular attribute value appearances in a set of rules and a respective number of attribute value matches comprising range based matches based on range based appearances for the each specific attribute value, wherein the processor determines the decision tree based on information entropy values and information gain values.

### BACKGROUND

### Field of the Disclosure

The present disclosure relates generally to information processing and more specifically to processing information according to a decision tree.

### Background of the Disclosure

A decision tree is used as a predictive model that maps observation about an item to conclusions about the item's target value. Decision trees are used in data mining, statistics, machine learning and, in our case, network classification. The efficiency of a decision tree is typically measured by the time takes to find the target value (the outcome decision). Decision trees have historically not supported ranges of values implemented at particular nodes of the decision tree. Inefficient decision trees can require high levels of processor activity, which increases costs and limits other processing activities.

### BRIEF DESCRIPTION OF THE DRAWINGS

The present disclosure may be better understood, and its numerous features and advantages made apparent to those skilled in the art by referencing the accompanying drawings.

FIG. 1 is a block diagram illustrating an apparatus in accordance with at least one embodiment.

FIG. 2 is a flow diagram illustrating a method in accordance with at least one embodiment.

FIG. 3 is a block diagram illustrating a decision tree in accordance with at least one embodiment.

The use of the same reference symbols in different drawings indicates similar or identical items.

### DETAILED DESCRIPTION OF THE DRAWINGS

A processor is configured to process information according to attribute value criteria, any of which can be a range of values, organized as a decision tree and used to determine whether a branch is to be taken at a node of the decision tree. For an attribute value criterion that is a range of values, a branch is taken for any value within the range of values.

Each of the attribute value criteria is assigned a respective priority value. A rule may specify, for each of several attributes, a particular attribute value or a range of attribute values. In the case of a range of attribute values, an attribute value match occurs when an attribute has any value within that range of attribute values.

A processor is configured to count, for each specific attribute value, a respective number of particular attribute value appearances in a set of rules. Thus, for example, for a specific attribute value of zero, the processor may count all of the appearances, in a set of rules, of the particular attribute value zero, not including any ranges of values that may match the attribute value zero. The processor may continue to individually count appearances, in the set of rules, of other particular attribute values, such as one, two, three, and so on. In addition to counting all of the appearances of the particular attribute values, the processor is further configured to count, for each specific attribute value, a respective number of appearances in the set of rules of a matching value for each specific attribute value, including in the count instances where the respective specific attribute value is within a range of attribute values for an attribute, as specified by a rule. For example, if a rule specifies for an attribute a range of values of all even numbers (e.g., all binary numbers ending in zero as the one's binary digit), a count for the specific attribute value of zero would include the range specified by the rule as an appearance, but a count for the specific attribute values of one would not include the same range as an appearance, as the binary representation of zero ends in zero as the one's binary digit, but the binary representation of one does not.

While the rules may specify values for each of several attributes, a decision tree based on the rules may make a decision at a given node with respect to a particular attribute, without regard, at that node, to other attributes to which the rules may pertain. As different attributes may have a lesser or greater effect in furthering a decision process to determination of a target value identified by a rule, the order in which the attributes are considered by the decision tree can affect the efficiency of the decision making process. The processor determines the decision tree based on information entropy values and information gain values, which are determined from the effect of the attribute value criteria on advancing the decision making process at a given node of the decision tree.

Information gain measures how well a given attribute separates the training examples according to their target classification. In general terms, the expected information gain IG is the change in information entropy H from a prior state to a state that takes some information as given:

IG(R,x)=H(R)−H(R|x)

where ‘R’ is a collection of examples and ‘x’ is a selected attribute from the collection ‘R’

Information entropy is a measure in information theory which characterizes the impurity of an arbitrary collection of examples. An equation for information entropy H(R) is shown below:

$$H ( R ) = {\sum }_{i = 1}^{c} - {p}_{i} {log}_{2} {p}_{i}$$

For example, if one attribute value criterion has a greater effect on reducing information entropy (e.g., impurity) of possible outcomes than another attribute value criterion, the attribute value criterion having greater effect is said to have higher information gain than the other attribute value criterion and is thus assigned to a higher node on the decision tree. The ability to efficiently implement decision making based on a range of values can allow for use of lower cost processors and can support additional processing activities, as examples.

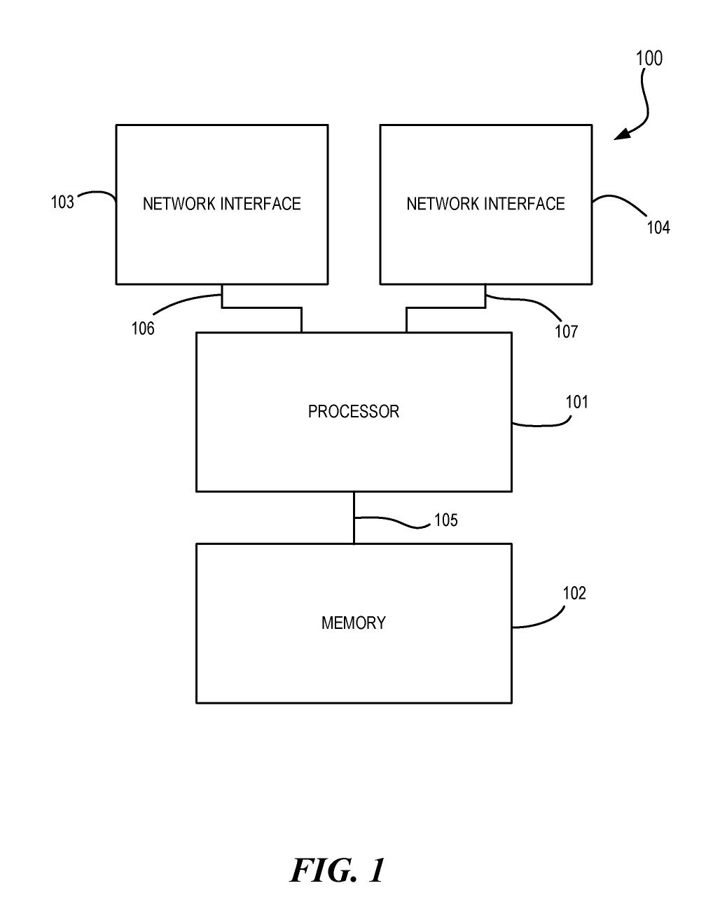

FIG. 1 is a block diagram illustrating an apparatus in accordance with at least one embodiment. The apparatus 100 of FIG. 1 comprises processor 101, memory 102, network interface 103, and network interface 104. As an example, apparatus 100 can be a network node, for example, a network router or another device on a network that forwards network traffic, such as packets, according to specified criteria, such as rules.

Processor 101 is connected to memory 102 via interconnect 105. Processor 101 is connected to network interface 103 via interconnect 106. Processor 101 is connected to network interface 104 via interconnect 107. The various interconnects disclosed herein are used to communicate information between various modules either directly or indirectly. For example, an interconnect can be implemented as a passive device, such as one or more conductive traces, that transmits information directly between various modules, or as an active device, whereby information being transmitted is buffered, e.g., stored and retrieved, in the processes of being communicated between devices, such as at a first-in first-out memory or other memory device. In addition, a label associated with an interconnect can be used herein to refer to a signal and information transmitted by the interconnect. For example, data signal transmitted via interconnect 105 can be referred to herein as signal 105.

Processor 101 can receive network traffic via, for example, network interface 103 and forward the network traffic via, for example, network interface 104. Processor 101 can store network traffic messages being forwarded in memory 102. Processor 101 can store information based on a specified routing criteria in memory 102. For example, processor 101 can store in memory 102 a representation of a decision tree for making decisions with the forwarding of network traffic. The information stored by processor 101 can include rules, information related to information entropy calculations pertaining to the rules, information related to information gain calculations based on the information entropy calculations, and counts of numbers of occurrences, for each specific attribute value, of a respective number of specific attribute value appearances in a set of rules and a respective number of appearances of the each specific attribute value, including range based appearances wherein the respective specific attribute value is within a specified range.

Processor 101 can forward incoming packets received, for example, at network interface 103, for transmission as outgoing packets, for example, at network interface 104. Processor 101 can be configured to process the incoming packets according to attribute value criteria organized as a decision tree, wherein an attribute value criterion of the attribute value criteria is a range of attribute values that can be associated with a particular incoming packet, wherein each of the attribute value criteria is assigned a respective priority value. Processor 101 can be configured to count, for each specific attribute value, a respective number of specific attribute value appearances in a set of rules and a respective number of appearances of the each specific attribute value, including range based appearances wherein the respective specific attribute value is within a specified range. Processor 101 determines the decision tree based on information entropy values and information gain values. Processor 101 uses the decision tree to determine the action it should take for forwarding the packets.

The decision tree can be an N-ary balanced tree. As a decision tree is constructed, a branch in the decision tree is added at a location in the decision tree to maximize information gain. The information gain is determined according to a difference of information entropy values. The information entropy values are determined based on the respective number of specific attribute value appearances in the set of rules and the respective number of appearances of the each specific attribute value. The decision tree is arranged in order of decreasing information gain with increasing distance from a root of the decision tree. The information entropy values can recalculated for remaining attributes not including a first information entropy value after a first attribute having the first information entropy value has been assigned to a preceding branch of the decision tree, or the information entropy values determined at an initial calculation can be used for remaining attributes to add additional branches of the decision tree after being used to add the first branch of the decision tree.

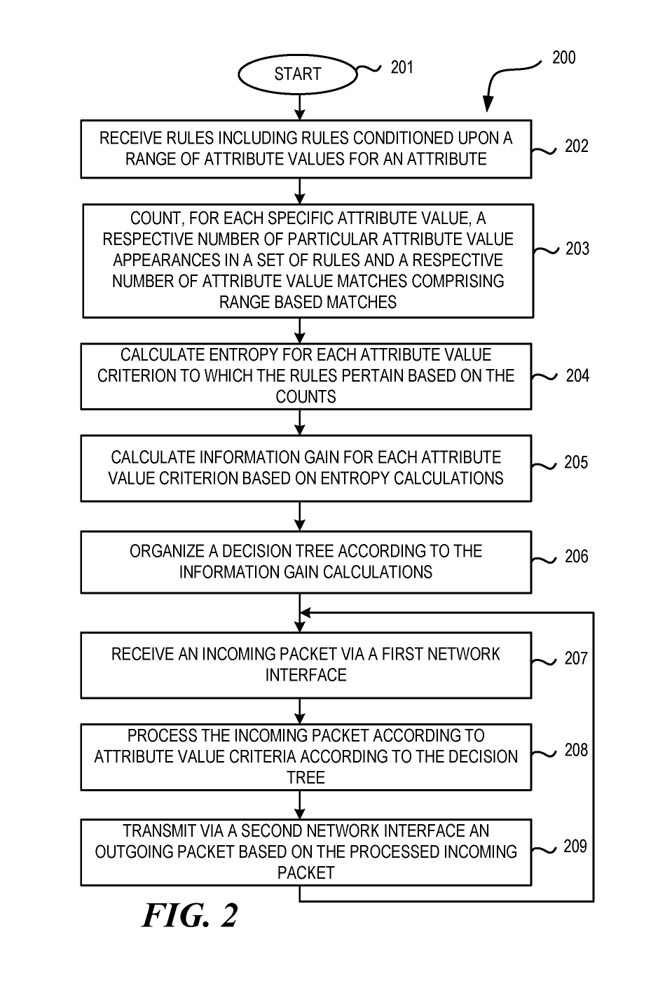

FIG. 2 is a flow diagram illustrating a method in accordance with at least one embodiment. Method 200 comprises block 201. Method 200 further comprises block 202. At block 202, rules are received, including rules conditioned upon a range of attribute values for an attribute. As a rule may specify a condition and an action to be taken if that condition is met, the action may be taken if an attribute value is anywhere within the range of attribute values in the case of a rule conditioned upon a range of attribute values. Method 200 further comprises block 203. At block 203, a count is performed, for each specific attribute value, to count a respective number of particular attribute value appearances of only a specific attribute value with respect to an attribute in a set of rules. A count is also performed to count a respective number of attribute value matches of each attribute value, including range based matches based on range based appearances wherein the attribute value is included in a range that may include other values. Method 200 further comprises block 204. At block 204, information entropy is calculated for each attribute value criterion to which the rules pertain based on the counts. Method 200 further comprises block 205. At block 205, information gain is calculated for each attribute value criterion based on the information entropy calculations. Method 200 further comprises block 206. At block 206, the decision tree is organized according to the information gain calculations.

Method 200 further comprises block 207. Blocks 201 through 206 can be performed initially to prepare the decision tree for use. Blocks 207 through 209 can be performed at run time, to use the decision tree, after the decision tree has been prepared for use.

At block 207, an incoming packet is received via a first network interface. Method 200 further comprises block 208. At block 208, the incoming packet is processed according to attribute value criteria according to the decision tree. Method 200 further comprises block 209. At block 209, an outgoing packet is transmitted via a second network interface based on the processed incoming packet. The second network interface can be a different interface from the first network interface or the same interface as the first network interface. From block 209, method 200 can return to block 207 to continue processing incoming packets.

In accordance with at least one embodiment, attribute values in a form of a range of attribute values, as opposed to a single specific attribute value, can be used as decision criteria. Such decision criteria can be used, either with or without other decision criteria, which may include either or both of single specific attribute values and other range-based attribute values. Range-based attribute values can be used for a separate parameter or for a portion of a parameter that has at least one other portion, such as a portion for which a single specific attribute value can be used.

A decision tree may be constructed according to a decision tree learning process and used according to a runtime decision making process. As an example, steps 202-206 of method 200 provide a decision tree learning process, and steps 207-209 of method 200 provide a runtime decision making process. The decision tree learning process of method 200 can result in an optimized decision tree, which can provide an optimized runtime decision making process. Accordingly, at least one embodiment can reduce the execution time of the decision making process, reduce the processor instruction execution of the decision making process, and support ranges in the decision attributes.

One approach to a decision tree learning process is referred to as Iterative Dichotomiser 3 (ID 3). ID3 constructs decision tree by employing a top-down, greedy search through the given sets of training data to test each attribute at every node. A “top-down” search begins at a beginning node of the decision tree (e.g., at the top of the decision tree) and continues to nodes at successive stages of the decision tree based on decisions at the preceding nodes. The term “greedy” refers to following a problem solving heuristic of making a locally optimal choice at each stage. However, in many cases, a greedy approach does not yield a globally optimal solution. ID3 uses the statistical property of information gain to select which attribute to test at each node in the tree.|_{[RS1]}

One example of apparatus in which the creation and use of a decision tree can be useful is a network node that makes decisions for the forwarding of network traffic. For example, a network router can use a decision tree to determine how to forward packets of data received by the network router. A network node, such as a network node in an internetwork or cloud network environment, can use an access control list (ACL). The ACL can serve several purposes, most notably in filtering network traffic and securing critical networked resources. Each of the ACL table entries is called a rule. The ACL rule is comprised of three parts. Firstly, a match key can be constructed by one or more match fields. Each of the match fields is described as a range. For example: IPv4 range from 10.0.0.0 to 10.0.0.255. Secondly, a result or action is specified by the ACL rule. If there was a lookup match in the key then the action to be performed is described in this field. In a firewall, for example, this action can be either permit or deny the packet to be received. Thirdly, a rule priority is assigned to the rule. If a lookup match occurs on more than one match keys (that are part of several rules) the highest priority rule will be chosen. Table 1 below shows an example of an ACL comprising four rules, identified by rule IDs 1 through 4.

TABLE 1

| | | | | | | Traffic | | |
|---|---|---|---|---|---|---|---|---|
| ID | Proto | Source | Port | Destination | Port | Direction | Action | Description |
| 1 | * | * | * | * | * | Outgoing | Allow | Allow all |
| | | | | | | | | outgoing |
| 2 | TCP | * | * | 10.0.0.0/8 | 22 | Incoming | Allow | SSH |
| 3 | TCP | * | * | 10.0.0.0/8 | 80 | Incoming | Allow | Web |
| 4 | * | * | * | * | * | Incoming | Deny | Deny all |
| | | | | | | | | remaining |

A high performance ACL lookup solution can be obtained by using a decision tree. Such a solution can provide better performance than Ternary Content-Addressable Memory (TCAM) as it can accommodate thousands to millions of rules without having a high cost hardware engine. In accordance with such a solution, an ACL is implemented using a multiple output decision tree as it can match several target values (actions) and choose the highest priority one of the matching targets.

By using an optimized decision tree according to at least one embodiment, calculations performed by a processor making decisions according to the decision tree can be relatively simple and efficient, which can allow a relatively simple, inexpensive processor, such as a real time embedded processor, to make decisions, even those involving large numbers of rules, quickly and efficiently. An optimal matching target value can be selected from multiple matching target values, with each of the matching target values having a respective priority. The processing according to the decision tree will return the highest priority target value for a multi-output decision tree.

Table 2 below gives as an example of eight different rules. Each rule contains four attributes. Each attribute value is of two bits in size (allowing four options). The attribute values can be expressed, for example, as binary, decimal, or hexadecimal, with a binary value denoted by the prefix 0b, a decimal value denoted by the prefix 0d, and a hexadecimal value denoted by the prefix 0x. An attribute value may be a specific attribute value that pertains to only that single specific attribute value or an attribute value that can include a range that includes multiple values. For example, Rule 8 on attribute 0 is shown as 0b**, with * being a wildcard value for each digit (with 0b denoting each digit to be a binary digit, or bit). As both bits of rule 8 on attribute 0 are shown as wildcard values, either bit can be have a bit value of zero or a bit value of one. Accordingly, rule 8 on attribute 0 has a range of possible values from 0 to 3, as any of 0b00, 0b01, 0b10, and 0b11 are within the range of attribute value 0b**. The range changes the calculated probability of each of the target values.

TABLE 2

| | 0 | 1 | 2 | 3 | Target Value | Priority |
|---|---|---|---|---|---|---|
| Rule 1 | 0x1 | 0x1 | 0b1* | 0b** | A | 4 |
| Rule 2 | 0x1 | 0x2 | 0b1* | 0b** | B | 5 |
| Rule 3 | 0x3 | 0x2 | 0x0 | 0b0* | C | 4 |
| Rule 4 | 0x3 | 0x3 | 0x2 | 0x1 | D | 6 |
| Rule 5 | 0x2 | 0x1 | 0x3 | 0b1* | E | 3 |
| Rule 6 | 0x2 | 0x3 | 0x1 | 0b0* | F | 7 |
| Rule 7 | 0x1 | 0b** | 0x0 | 0b** | G | 2 |
| Rule 8 | 0b** | 0b** | 0b** | 0b** | H | 1 |

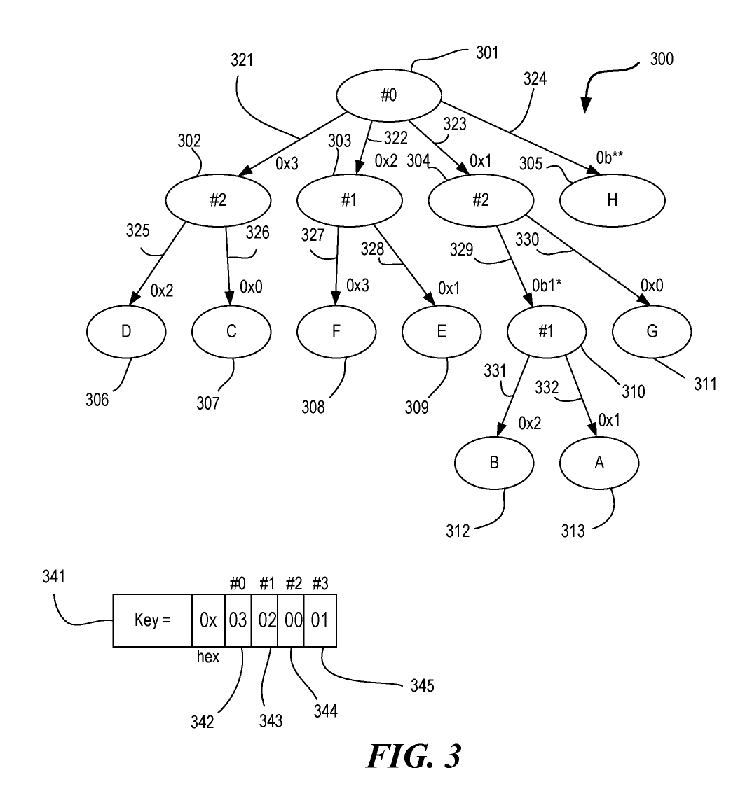

FIG. 3 is a block diagram illustrating a decision tree in accordance with at least one embodiment. Decision tree 300 corresponds to the rules set forth in Table 2 above. Decision tree 300 comprises root node 301, first level nodes 302, 303, 304, and 305, second level nodes 306, 307, 308, 309, 310, and 311, and third level nodes 312 and 313. Branch 321 leads from root node 301 to first level node 302. Branch 322 leads from root node 301 to first level node 303. Branch 323 leads from root node 301 to first level node 304. Branch 324 leads from root node 301 to first level node 324. Branch 325 leads from first level node 302 to second level node 306. Branch 326 leads from first level node 302 to second level node 307. Branch 327 leads from first level node 303 to second level node 308. Branch 328 leads from first level node 303 to second level node 309. Branch 329 leads from first level node 304 to second level node 310. Branch 330 leads from first level node 304 to second level node 311. Branch 331 leads from second level node 310 to third level node 312. Branch 332 leads from second level node 310 to third level node 313.

A key value 341 comprises a plurality of attribute values 342, 343, 344, and 345. Attribute value 342 corresponds to attribute #0 of Table 2. Attribute value 343 corresponds to attribute #1 of Table 2. Attribute value 344 corresponds to attribute #2 of Table 2. Attribute value 345 corresponds to attribute #3 of Table 2.

At root node 301, attribute value 342 for attribute #0 is considered. Branch 321 is a valid branch from root node 301 that can be taken when attribute #0 has an attribute value 342 of 0x3 (i.e., a hexadecimal value of 3). Branch 322 is a valid branch from root node 301 that can be taken when attribute #0 has an attribute value 342 of 0x2 (i.e., a hexadecimal value of 2). Branch 323 is a valid branch that can be taken when attribute #0 has an attribute value 342 of 0x1 (i.e., a hexadecimal value of 1). Branch 324 is a valid branch that can be taken when attribute #0 has an attribute value 342 that conforms to a pattern 0b** (i.e., either a one or zero for a first binary digit of attribute value 342 and either a one or a zero for a second binary digit of attribute value 342).

As attribute value 342 is equal to 0x03 according to key 341, branches 321 and 324 are valid branches. As branch 324 terminates at first level node 305, labelled H, which has no further branches extending from it, first level node 305 is a valid outcome of decision tree 300 for key 341. First level node 305 has a priority value associated with it which can be used to compare its priority to the priority of any other nodes for valid outcomes to allow selection of a valid outcome of highest priority.

Branch 321 leads to first level node 302. At first level node 302, an attribute value of attribute #2 is considered. If attribute #2 has a value of 0x2, branch 325 is a valid branch. If attribute #2 has a value of 0x0, branch 326 is a valid branch. As attribute #2 has an attribute value 344 equal to 0x00 according to key 341, branch 325 is not a valid branch, but branch 326 is a valid branch. Branch 326 leads to second level node 307, labelled C, which has no further branches extending from it. Thus, second level node 307 is a valid outcome of decision tree 300 for key 341. Second level node 307 has a priority value associated with it which can be used to compare its priority to the priority of any other nodes for valid outcomes to allow selection of a valid outcome of highest priority.

The output N-ary balanced decision tree 300 has three matched branches, namely, branch 324, branch 321, and branch 326. An N-ary decision tree is a rooted tree in which each node branches in N or fewer ways from that node to a corresponding N or fewer succeeding nodes, where N is a non-negative integer. As show below in Table 3, two key comparisons are performed, namely, key comparisons for Rules 3 and 8. All target values are matched to the key. The process is performed using a minimum lookup time.

TABLE 3

| | 0 | 1 | 2 | 3 | Target Value | Priority |
|---|---|---|---|---|---|---|
| Rule 3 | 0x3 | 0x2 | 0x0 | 0b0* | C | 4 |
| Rule 8 | 0b** | 0b** | 0b** | 0b** | H | 1 |

As shown above, first level node 305 and second level node 307 are valid outcomes of the decision tree for the value 0x03020001 of key 341, as shown in FIG. 3. Second level node 307 corresponds to Rule 3 of Table 3, as attribute #0 has a value of 0x3 and attribute #2 has a value of 0x0. Rule 3 specifies a value of 0x2 for attribute #1 and a range of 0b0* for attribute #3, which the value of 0x02 for attribute #1 and the value of 0x01 for attribute #3, as shown in key 341 of FIG. 3 both satisfy. First level node 305 corresponds to Rule 8 of Table 3, as attribute #0, as branch 324 is followed if attribute #0 is within the range 0b**, which permits any value for the two bits of attribute #0, consistent with Rule 8. Rule 8 also permits any values for the two bits of each of attributes #1, #2, and #3, as it specifies a range of 0b** for each of those attributes. Thus, the values 343, 344, and 345 of each of attributes #1, #2, and #3 of key 341 of FIG. 3 also satisfy Rule 8.

In accordance with at least one embodiment, a counting table is created. The counting table can simplify information entropy and information gain calculation. As an example, in accordance with Table 2 above, a counting table is created as shown in Table 4 below.

TABLE 4

| | 0x0 | 0x1 | 0x2 | 0x3 | 0b1* | 0b0* | 0b** | CNT |
|---|---|---|---|---|---|---|---|---|
| Attribute 0 | 0, 1 | 3, 4 | 2, 3 | 2, 3 | 0 | 0 | 1 | 11 |
| Attribute 1 | 0, 2 | 2, 4 | 2, 4 | 2, 4 | 0 | 0 | 2 | 14 |
| Attribute 2 | 2, 3 | 1, 2 | 1, 4 | 1, 4 | 2 | 0 | 1 | 13 |
| Attribute 3 | 0, 6 | 1, 7 | 0, 5 | 0, 5 | 1 | 2 | 4 | 23 |

In Table 4, all the possible attribute value options are given in the columns. For cells without a mask value in the table there are two values (Xi, Xm). The value ‘Xi’ represents the number of appearances for a specific attribute value in the original table. The value ‘Xm’ represents the number of appearances for a specific attribute value including all ranges in the same attribute that match this value. For cells with a mask value there is only one value Xi which represents the number of appearances for a specific attribute value in the original table. CNT equals to the sum of all ‘Xm’ in a specific attribute value. For example, the cell that corresponds to attribute 2 having a value 0x3 is shown in the third row and fourth column of Table 4 as “1, 4” for its (Xi, Xm) values. In that case, ‘Xi’ equals 1 as the value 0x3 appears only once in attribute 2 column of Table 2 (in the row for Rule 5). ‘Xm’ equals 4 as Xm=1 (for Xi)+2 (for 0b1*)+1 (for 0b**), where Xi=0x3 is for Rule 5, 0b1* is for Rules 1 and 2, and 0b** is for Rule 8 of Table 2.

In accordance with at least one embodiment, the functions shown below are used (for the uniform distribution case) with the counting table shown in Table 4 to calculate the information entropy and information gain, where 2ⁿ represent the number of possibilities of a specific value. For example, in the case of the value=0b1*, 2ⁿ=2; and, in the case of the value=0b**, 2ⁿ=4.

$$H ( R ) = {\sum }_{i ∈ R} - {p}_{i} {log}_{2} {p}_{i}$$

$$H ( {R}_{attribute \#} ) = \sum [ \frac{{X}_{i} \times {2}^{n}}{CNT} log ( \frac{CNT}{{2}^{n}} ) ] + ( 1 - \sum [ \frac{{X}_{i} \times {2}^{n}}{CNT} ] ) log ( CNT )$$

$$H ( R \vert X ) = - {\sum }_{x ∈ X} p ( x ) {log}_{2} p ( i \vert x )$$

$$H ( {R}_{attribute \#} \vert X ) = \sum [ ( \frac{{X}_{m}}{CMT} ) log {X}_{m} ]$$

$$IG ( {R}_{attribute \#} , x ) = H ( {R}_{attribute \#} ) - H ( {R}_{attribute \#} \vert x )$$

The next branch in the decision tree is chosen according to the following function, which selects the maximum value of the function IG(R_{attribute #}, x):

Max(IG(R_{attribute #},x))

Calculations to determine information entropy can be based on the following:

Given:

$$p ( A ) = \frac{{X}_{a}}{Y} ; p ( B ) = \frac{{X}_{b}}{Y} ; … ; p ( H ) = \frac{{X}_{h}}{Y} ;$$

Y is the lowest common denominator (LCD)

Bit masks are an example of out an attribute value ‘H’ can include a range, rather than being limited to as single specific value.

C=2ⁿ−1(‘n’ is the number of bit masks)

Probability including range can be expressed according to the following:

$$: p ( A ) = \frac{{X}_{a}}{Y + C} ; p ( B ) = \frac{{X}_{b}}{Y + C} ; … ; p ( H ) = \frac{{X}_{h + C}}{Y + C} ;$$

For the special case of a uniform target distribution, the following applies, consistent with the rules set forth in Table 2 above:

p(A)=p(B)= . . . =p(H)=⅛,C=3,Y=8

Probability including range for the uniform target distribution can be expressed according to the following:

p(A)=p(B)= . . . =p(G)= 1/11,p(H)= 4/11

Next, information entropy can be calculated for all target distributions as follows:

H(R_{attribute 0}),

H(R_{attribute 1}),H(R_{attribute 2}) and H(R_{attribute 3})

using:

$$H ( R ) = {\sum }_{i ∈ R} - {p}_{i} {log}_{2} {p}_{i}$$

Subset information entropy can be calculated as follows:

$$H ( R \vert X ) = - {\sum }_{x ∈ X} p ( x ) {\sum }_{i ∈ R} p ( i \vert x ) {log}_{2} p ( i \vert x )$$

In case of uniform distribution:

$${\sum }_{i ∈ R} p ( i \vert x ) {log}_{2} p ( i \vert x ) = {log}_{2} p ( i \vert x )$$

which simplifies the subset information entropy calculation as follows:

$$H ( R \vert H ) = - {\sum }_{x ∈ X} p ( x ) {log}_{2} p ( i \vert x )$$

In the example based on Table 2 above,

$$H ( {R}_{attribute 0} ) = \frac{4}{11} log \frac{11}{4} + 7 \times \frac{1}{11} log 11 = 2.20 + 0.49 = 2.69$$

$$H ( {R}_{attribute 0} \vert X ) = \frac{4}{11} log 4 + 2 \times \frac{3}{11} log 3 = 0.72 + 0.43 = 1.15$$

The same calculation is performed for the other attributes, as follows:

H(R_{attribute 1}),H(R_{attribute 2}),H(R_{attribute 3});

H(R_{attribute 1}|X),H(R_{attribute 2}|X),H(R_{attribute 3}|X)

The information gain for each attribute is calculated, and the maximum information gain determines the next branch decision, as follows:

I_{G}(R_{attribute #})=H(R)−H(R|X)

I_{G}(R_{attribute 0})=2.69−1.15=1.54

I_{G}(R_{attribute 1})=2.64−1.14=1.50

I_{G}(R_{attribute 2})=2.77−1.74=1.03

I_{G}(R_{attribute 3})=2.77−2.52=0.25

In the example based on Table 2 above, attribute #0 is chosen as the root of the decision tree 300 of FIG. 3.

The values calculated above can be used to construct an entire decision tree based on a single set of calculations, such that no further iterations of calculations are required, or the values calculated above can be used to construct only a portion of the decision tree, such as a first node of the decision tree, with additional iterations of calculations used to construct remaining portions of the decision tree, such as additional nodes. As an example, a separate set of calculations can be performed for each sub tree of a plurality of sub trees of the decision tree. For example, the information gain values can be recalculated for nodes not yet added to the decision tree until the decision tree is complete.

An example of a sub tree of decision tree 300 includes nodes 304, 310, 311, 312, and 313. Such a sub tree conforms to Rules 1, 2, and 7 of Table 2 above. The exemplary sub tree is shown below in Table 6.

TABLE 6

| Byte Num | 0 | 1 | 2 | 3 | Target Value | Priority |
|---|---|---|---|---|---|---|
| Rule 1 | 0x1 | 0x1 | 0b1* | 0b** | A | 4 |
| Rule 2 | 0x1 | 0x2 | 0b1* | 0b** | B | 5 |
| Rule 7 | 0x1 | 0b** | 0x0 | 0b** | G | 2 |

In accordance with at least one embodiment, a network node comprises a first interface for receiving incoming packets, a second interface for sending outgoing packets, and a processor. The processor is configured to count, for each specific attribute value, a respective number of specific attribute value appearances in a set of rules and a respective number of appearances of each attribute value, comprising range based appearances, the respective specific attribute value being within a specified range. The processor is further configured to determine a decision tree based on information entropy values and information gain values that are based on the count of the respective number of specific attribute value appearances and the respective number of appearances of each attribute value comprising the range based appearances. The processor is further configured to process the incoming packets according to attribute value criteria organized as a decision tree, an attribute value criterion of the attribute value criteria being a range of attribute values, each of the attribute value criteria assigned a respective priority value.

In accordance with at least one embodiment, the decision tree is an N-ary balanced tree. In accordance with at least one embodiment, a next branch in the decision tree is added at a location in the decision tree to maximize information gain. In accordance with at least one embodiment, the information gain is determined according to a difference of information entropy values. In accordance with at least one embodiment, the information entropy values are determined based on the respective number of specific attribute value appearances in the set of rules and the respective number of appearances of the each specific attribute value. In accordance with at least one embodiment, the decision tree is arranged in order of decreasing information gain with increasing distance from a root of the decision tree. In accordance with at least one embodiment, the information entropy values are recalculated for remaining attributes not including a first information entropy value after a first attribute having the first information entropy value has been assigned to a preceding branch of the decision tree.

In accordance with at least one embodiment, a method for routing packets in a network comprises receiving incoming packets at a first interface, processing the incoming packets by a processor according to attribute value criteria organized as a decision tree, wherein an attribute value criterion of the attribute value criteria is a range of attribute values, wherein each of the attribute value criteria is assigned a respective priority value, wherein the processor is configured to count, for each specific attribute value, a respective number of specific attribute value appearances in a set of rules and a respective number of appearances of the each specific attribute value, including range based appearances wherein the respective specific attribute value is within a specified range, wherein processor determines the decision tree based on information entropy values and information gain values, and transmitting outgoing packets at a second interface based on the processing of the incoming packets. In accordance with at least one embodiment, the decision tree is an N-ary balanced tree. In accordance with at least one embodiment, the method further comprises adding a next branch in the decision tree at a location in the decision tree to maximize information gain. In accordance with at least one embodiment, the method further comprises determining the information gain according to a difference of information entropy values. In accordance with at least one embodiment, the information entropy values are determined based on the respective number of specific attribute value appearances in the set of rules and the respective number of appearances of the each specific attribute value. In accordance with at least one embodiment, the decision tree is arranged in order of decreasing information gain with increasing distance from a root of the decision tree. In accordance with at least one embodiment, the method further comprises recalculating remaining information entropy values for remaining attributes not including a first information entropy value for a first attribute after the first attribute having the first information entropy value has been assigned to a preceding branch of the decision tree.

In accordance with at least one embodiment, a first processor performs the counting and the determining, while a second processor performs the processing of the incoming packets. In accordance with at least one embodiment, the first processor and the second processor are distinct and separate processors. In accordance with at least one embodiment, the first processor and the second processor are co-located at a single network node. In accordance with at least one embodiment, the first processor is located at a first network node, and the second processor is located at a second network node apart from the first network node. In accordance with at least one embodiment, the first processor performs the counting and determining in advance of the receiving of the incoming packets at the first interface, and the second processor performs the processing of the incoming packets in real time with negligible delay as the incoming packets are received.

In accordance with at least one embodiment, an integrated circuit comprises a memory and a network processor coupled to the memory, the network processor for routing incoming packets for transmission as outgoing packets, the network processor configured to process the incoming packets according to attribute value criteria organized as a decision tree, wherein an attribute value criterion of the attribute value criteria is a range of attribute values, wherein each of the attribute value criteria is assigned a respective priority value, wherein the processor is configured to count, for each specific attribute value, a respective number of specific attribute value appearances in a set of rules and a respective number of appearances of the each specific attribute value, including range based appearances wherein the respective specific attribute value is within a specified range, wherein processor determines the decision tree based on information entropy values and information gain values. In accordance with at least one embodiment, the decision tree is an N-ary balanced tree. In accordance with at least one embodiment, a next branch in the decision tree is added at a location in the decision tree to maximize information gain. In accordance with at least one embodiment, the information gain is determined according to a difference of information entropy values. In accordance with at least one embodiment, the information entropy values are determined based on the respective number of specific attribute value appearances in the set of rules and the respective number of appearances of the each specific attribute value. In accordance with at least one embodiment, the decision tree is arranged in order of decreasing information gain with increasing distance from a root of the decision tree.

In accordance with at least one embodiment, an apparatus comprises a memory and a processor coupled to the memory. The processor is configured to receive rules having rule attribute values, to store the rule attribute values in the memory, to count, for each specific attribute value of the rule attribute values, a respective number of specific attribute value appearances in the rules and a respective number of appearances of each attribute value comprising range based appearances in the rules, the respective specific attribute value being within a specified range, the processor further configured to determine a decision tree based on information entropy values and information gain values that are based on the count of the respective number of specific attribute value appearances and the respective number of appearances of each attribute value comprising the range based appearances. In accordance with at least one embodiment, the decision tree is an N-ary balanced tree. In accordance with at least one embodiment, a next branch in the decision tree is added at a location in the decision tree to maximize information gain. In accordance with at least one embodiment, the information gain is determined according to a difference of information entropy values. In accordance with at least one embodiment, the information entropy values are determined based on the respective number of specific attribute value appearances in the set of rules and the respective number of appearances of the each specific attribute value. In accordance with at least one embodiment, the decision tree is arranged in order of decreasing information gain with increasing distance from a root of the decision tree. In accordance with at least one embodiment, the processor is further configured to make decisions according to attribute value criteria organized as a decision tree, an attribute value criterion of the attribute value criteria being a range of attribute values, each of the attribute value criteria assigned a respective priority value.

In the foregoing description, the term “at least one of” is used to indicate one or more of a list of elements exists, and, where a single element is listed, the absence of the term “at least one of” does not indicate that it is the “only” such element, unless explicitly stated by inclusion of the word “only” or a similar qualifier.

The concepts of the present disclosure have been described above with reference to specific embodiments. However, one of ordinary skill in the art will appreciate that various modifications and changes can be made without departing from the scope of the present disclosure as set forth in the claims below. In particular, the particular types of applications for which processing according to a decision tree may be used may be varied according to different embodiments. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

What is claimed is:

1. A network node comprising:
a first interface for receiving incoming packets;
a second interface for sending outgoing packets; and
a processor configured to
count each specific attribute value of a plurality of specific attribute values, a respective number of particular attribute value appearances in a set of rules and a respective number of attribute value matches comprising range based matches based on range based appearances,
determine a decision tree based on information entropy values and information gain values, the information entropy values based on the count of the respective number of the particular attribute value appearances and the respective number of the attribute value matches, the decision tree leading to determination of target values, the target values used in the sending of the outgoing packets, and
process the incoming packets according to attribute value criteria organized as the decision tree, an attribute value criterion of the attribute value criteria being a range of attribute values, wherein a portion of the attribute value criteria lead to a matching target value among the target values of the decision tree, wherein each of the target values, including the matching target value, is assigned a respective priority value.

2. The network node of claim 1 wherein the decision tree is an N-ary balanced tree.

3. The network node of claim 2 wherein a next branch in the decision tree is added at a location in the decision tree to maximize information gain.

4. The network node of claim 3 wherein the information gain is determined according to a difference of information entropy values.

5. The network node of claim 4 wherein the information entropy values are determined based on the respective number of the particular attribute value appearances in the set of rules and the respective number of the attribute value matches for the each specific attribute value.

6. The network node of claim 5 wherein the decision tree is arranged in order of decreasing information gain with increasing distance from a root of the decision tree.

7. The network node of claim 6 wherein the information entropy values are recalculated for remaining attribute value criteria not including a first information entropy value after a first attribute value criterion having the first information entropy value has been assigned to a preceding branch of the decision tree.

8. A method for routing packets in a network, the method comprising:
counting, by a first processor, for each specific attribute value of a plurality of specific attribute values, a respective number of particular attribute value appearances in a set of rules and a respective number of attribute value matches comprising range based matches based on range based appearances;
determining, by the first processor, a decision tree based on information entropy values and information gain values;
receiving incoming packets at a first interface;
processing the incoming packets by a second processor according to attribute value criteria organized as a decision tree, wherein an attribute value criterion of the attribute value criteria is a range of attribute values, wherein a portion of the attribute value criteria lead to a matching target value among target values of the decision tree, wherein each of the target values, including the matching target value, is assigned a respective priority value; and
transmitting outgoing packets at a second interface based on the processing of the incoming packets by the second processor.

9. The method of claim 8 wherein the decision tree is an N-ary balanced tree.

10. The method of claim 9 further comprising:
adding, by the first processor, a next branch in the decision tree at a location in the decision tree to maximize information gain.

11. The method of claim 10 further comprising:
determining, by the first processor, the information gain according to a difference of information entropy values.

12. The method of claim 11 wherein the information entropy values are determined by the first processor based on the respective number of the particular attribute value appearances in the set of rules and the respective number of the attribute value matches for the each specific attribute value.

13. The method of claim 12 wherein the decision tree is arranged, by the first processor, in order of decreasing information gain with increasing distance from a root of the decision tree.

14. The method of claim 13 further comprising:
recalculating, by the first processor, remaining information entropy values for remaining attribute value criteria not including a first information entropy value for a first attribute value criterion after the first attribute criterion having the first information entropy value has been assigned to a preceding branch of the decision tree.

15. An apparatus comprising:
a memory; and
a processor coupled to the memory, the processor configured to receive rules having rule attribute values, to store the rule attribute values in the memory, to count, for each specific attribute value of the rule attribute values, a respective number of particular attribute value appearances in the rules and a respective number of attribute value matches of each attribute value comprising range based matches based on range based appearances in the rules, the processor further configured to determine a decision tree based on information entropy values and information gain values, the information entropy values based on the count of the respective number of the particular attribute value appearances and the respective number of attribute value matches.

16. The apparatus of claim 15 wherein the decision tree is an N-ary balanced tree.

17. The apparatus of claim 16 wherein a next branch in the decision tree is added at a location in the decision tree to maximize information gain.

18. The apparatus of claim 17 wherein the information gain is determined according to a difference of information entropy values.

19. The apparatus of claim 18 wherein the information entropy values are determined based on the respective number of the particular attribute value appearances in the set of rules and the respective number of the attribute value matches for the each specific attribute value.

20. The apparatus of claim 19 wherein the decision tree is arranged in order of decreasing information gain with increasing distance from a root of the decision tree.
